(19) United States
(12) Patent Application Publication
(10) Pub. No.: US 2007/0065059 A1
(43) Pub. Date: Mar. 22, 2007

(54) Bearing cap assembly

(76) Inventor: Peter R. Johnson, Ada, MI (US)

Correspondence Address: MCDONALD HOPKINS CO., LPA, 2100 BANK ONE CENTER, 600 SUPERIOR AVENUE, E., CLEVELAND, OH, 44114-2653, US

(21) Appl. No.: 11/481,589

(22) Filed: Jul. 6, 2006

Related U.S. Application Data
(60) Provisional application No. 60/696,754, filed on Jul. 6, 2005.

(51) Int. Cl. F16C 9/02

(52) U.S. Cl. 384/294

(57) ABSTRACT

A bearing cap assembly 5 generally comprising at least one bearing cap 10 having a mini-cap bearing cap 20 and a mini-cap 14. The bearing cap 10 having a shaft bore for receiving a balance shaft and a crankshaft bore for receiving a crankshaft upon connection of the bearing cap assembly 5 to an engine. The bearing cap 10 has a fault line extending between the mini-cap bearing cap 20 and the mini-cap 14 whereby split fracturing the bearing cap 10 along the fault line separates the mini-cap bearing cap 20 from the mini-cap 14. The balance shaft is secured between the mini-cap bearing cap 20 and the mini-cap 14.

### CROSS-REFERENCE TO RELATED APPLICATIONS

This application claims priority from U.S. Provisional Patent Application No. 60/696,754 filed on Jul. 6, 2005, which is hereby incorporated by reference.

### BACKGROUND

The present invention relates to a bearing cap assembly for offsetting or eliminating imbalance forces inherent in an engine, and more particularly to a supporting structure for housing balance shafts that to oppose the imbalance forces about a couple moment.

In reciprocating piston engines, imbalance forces are produced due to the mass of reciprocating parts. For instance, movement of cylinders of an engine cause vibrational forces, such as shaking, and unbalanced moments, such as, rotational forces in an opposite direction to the crankshaft. In order to eliminate or offset such forces, a balance shaft having a balancing weight can be provided to counterbalance and/or offset such forces.

In an engine of this type, the balance shaft is supported on a casing disposed in an oil pan below the cylinder block. The driving force of a crankshaft is transmitted therefrom to the balance shaft via a chain, a gear or the like. Typically, the balance shaft rotates the balance weight at twice the crankshaft revolution speed but in the opposite direction. The balance weight may consist of two equal masses positioned at opposite ends of the balance shaft to yield a radial force substantially equal and opposite to rotational forces produced by the engine. In addition, the rotating balance weight produces a couple moment about a central point of the balance shaft to substantially offset vibrational movement of the engine.

In general, the aforementioned balance shaft requires support at a plurality of positions. Further, a substantial amount of balancing torque is produced to offset vibrations of the engine, and, therefore, the balance shaft must be supported by a sufficiently rigid bearing structure. As such, bearing caps have journal portions therein to support the balance shaft. As is know in the art, to increase the strength of the journal portion, the journal portions are drilled through the bearing cap, often billet steel, so that the balance shaft is inserted from an axial direction and positioned within the journal portions. As such, the journal portions of the bearing caps must be manufactured to the largest diameter of the balance shaft. Accordingly, more material, such as billet steel, is used to produce the bearing cap than actually necessary. As a result, the engine carries additional weight reducing fuel efficiency.

In addition, the drilling of the bearing cap must be precise and often results in cracking of the bearing cap assembly. Even after drilling the bearing cap, machining is typically required to rigidly accommodate the balance shaft. As a result, a need exists for a bearing cap assembly requiring less machining and less time to manufacture.

There is a constant need in the art to reduce the weight of automotive components, increase the strength and machinability of components, and reduce costs in producing and manufacturing the automotive components. Any such improvements are constantly sought in the automotive industry. The present invention satisfies such a need by, for example, providing a modular bearing cup assembly having journal portions precisely formed by fracture splitting.

### SUMMARY OF THE INVENTION

The purpose of the present invention is to reduce and/or eliminate imbalance forces, such as vibrational and rotational forces, occurring during operation of the engine. The present invention provides a bearing cap assembly having a crankshaft bore and at least one bearing cap. The crankshaft bore connects the crankshaft of the engine to the balance shaft. The bearing cap rigidly supports the balance shaft and allows the balance shaft to rotate to offset the imbalance forces. The bearing cap is compacted and sintered to provide a rigid fit for the balance shaft. As a result, the present invention provides a bearing cap assembly requiring less machining, less material and reduced production and manufacturing costs. Numerous bearing caps may be incorporated into the bearing cap assembly as required to support any number of balance shafts.

### BRIEF DESCRIPTION OF THE DRAWING

Objects and advantages together with the operation of the invention may be better understood by reference to the following detailed description taken in connection with the following illustrations, wherein:

FIG. 1 is a perspective view of the bearing cap assembly.

FIG. 2 is an exploded perspective view of the bearing cap assembly of FIG. 1.

FIG. 3 is a side elevational view of FIG. 1

FIG. 4 is a top plan view of FIG. 1.

FIG. 5 is a bottom plan view of FIG. 1.

### DETAILED DESCRIPTION OF THE INVENTION

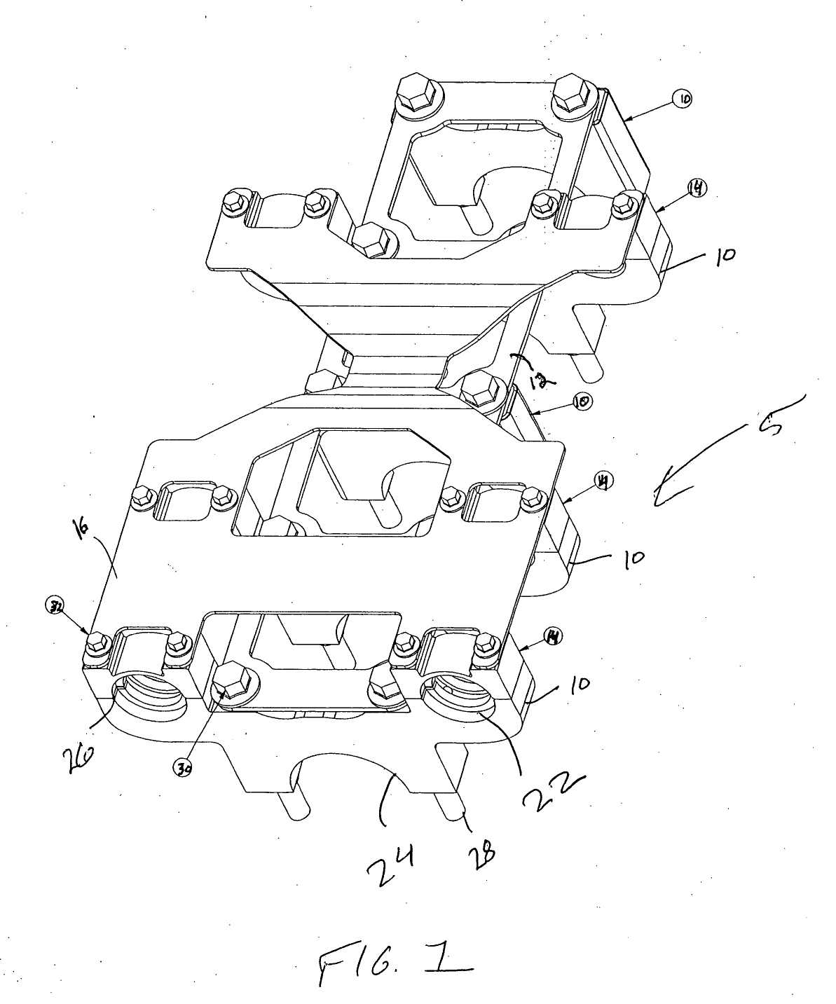

Referring now to the drawings, which show an embodiment of the invention only for the purpose of illustration and not for purposes of limiting the same, the bearing cap assembly 5 of the present invention generally comprises at least one bearing cap 10 connected to a lower plate 12. The bearing cap 10 is sized and shaped to receive a balance shaft (not shown). FIG. 1 illustrates a perspective view of an embodiment of the bearing cap 10 having two shaft bores. To this end, the bearing cap assembly 5 is sized and shaped for two balance shafts. Of course, the bearing cap assembly 5 of the present invention may be sized and shaped to receive any number of balance shafts without departing from the scope of the present invention.

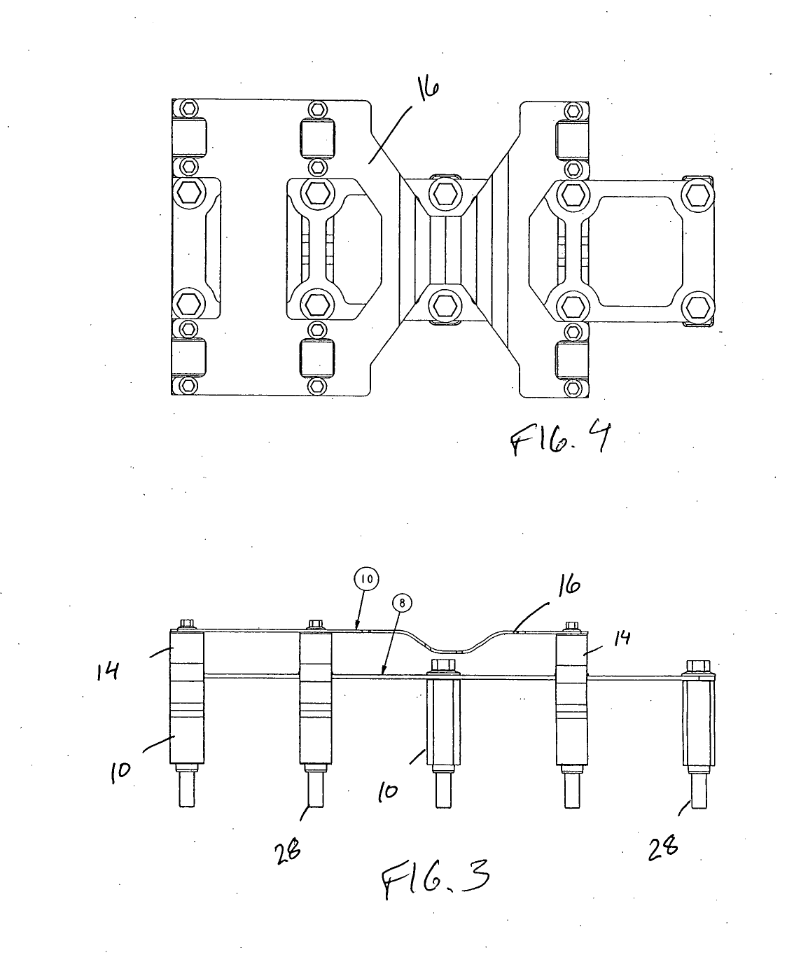

Each bearing cap 10 is connected to a corresponding mini-cap 14 and to an upper plate 16. In an embodiment, the upper plate 16 and associated mini-caps 14 are removable from the bearing caps 10. As an example, a fault line 26 extends between the bearing cap 10 and the mini-cap 14. The bearing cap 10 and/or the mini-cap 14 may be fracture split to provide a precisely confronting mini-cap joint face surface. In such an embodiment, the upper plate 16 secures the mini-caps 14 to the bearing caps 10. In an assembled position, the mini-caps 14 are located between the mini-caps 14 and the bearing caps 10 as best illustrated in FIG. 3.

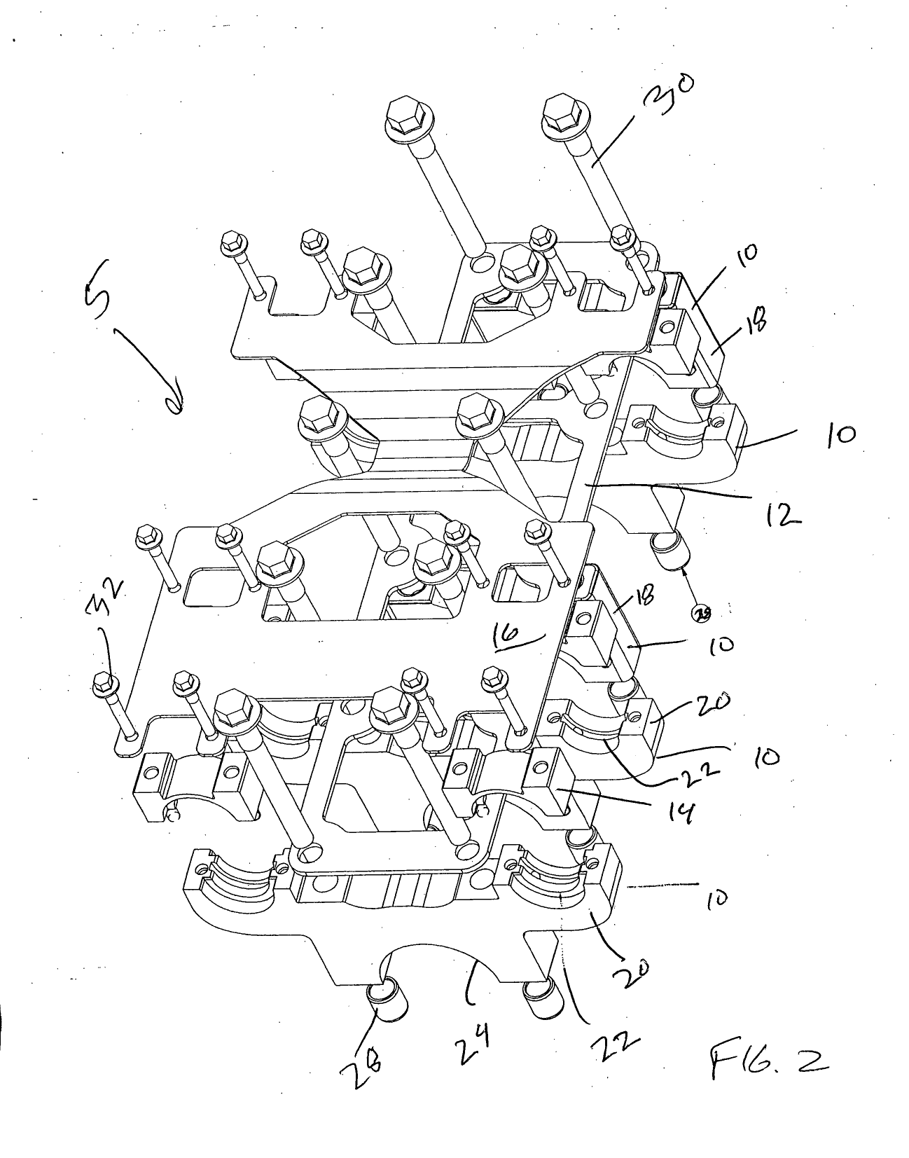

After fracture, the mini-caps 14 may be removed, for example, to be machined and/or to permit the insertion of balance shafts during component assembly onto an engine. To assemble the joint face surface, mini-cap bolts 32 secure the mini-cap 14 to the bearing cap 10. Connecting the mini-cap 14 to the bearing cap 10 forms a shaft bore having shaft journals 22 to rigidly fit and/or to secure the balance shaft, as generally illustrated in FIGS. 1 and 2. Such an arrangement is beneficial over insertion of the balance shaft axially through a shaft bore formed by drilling. For example, a drilled shaft bore fits much looser and causes vibrations and acoustical noise with the balance shaft. Additionally, the couple moment of the balance shaft may be altered by a loose fitting shaft bore causing a decrease in the effectiveness of the balance shaft to offset imbalance forces of the engine.

The bearing cap 10 has a crankshaft bore 24, as illustrated in FIG. 5, for connecting the bearing cap assembly 5 to an engine (not shown), and specifically, a crankshaft of an engine (not shown). In an embodiment illustrated in FIG. 1, the crankshaft bore 24 is located intermediate to opposing ends of the bearing caps 10. Accordingly, the crankshaft bore 24 receives the crankshaft at a position located between a first balance shaft and a second balance shaft (not shown) when the bearing cap assembly 5 is incorporated into the engine. FIG. 5 best illustrates a planar view of the crankshaft bore 24 which will connect to the crankshaft upon assembly into the engine.

As best illustrated in FIG. 2, the bearing cap assembly 5 has mini-cap bearing caps 20 and main bearing caps 18. Lower plate 12 connects each of the mini-cap bearing caps 20 to the main bearing caps 18. In a preferred embodiment, the bearing cap assembly 5 has two main bearing caps 18 and three sets of mini-cap bearing caps 20. One of ordinary skill in the art will appreciate that any number of main bearing caps 18 and/or mini-cap bearing caps 20 may be incorporated into the bearing cap assembly 5.

In an embodiment, the lower plate 12 is positioned on top of the main bearing caps 18 and connects to the mini-cap bearing caps 20, as illustrated in FIG. 2. The upper plate 16 connects the mini-caps 14 to the mini-cap bearing caps 20 to form shaft bores having balance shaft journals 22. The upper plate 16 and the lower plate 12 allow a modular construction of the bearing cap assembly 5, as illustrated in FIG. 2. Each mini-cap 14 is removable from each mini-cap bearing cap 20 for insertion of the balance shaft. To this end, the mini-caps 14 may be removed prior to insertion of the balance shaft. The balance shaft may be inserted onto the mini-cap bearing caps 20. As a result, upon assembly of the balance shaft, the mini-caps 14 rigidly secure the balance shaft to the mini-cap bearing caps 20.

In addition, the modular arrangement of the mini-cap bearing caps 20 with respect to the main bearing caps 18 may be changed, modified or otherwise rearranged in order to effectively connect the crank shaft and the balance shafts and/or to effectively offset imbalance forces caused by the engine. In addition, the modular construction of the bearing cap assembly 5 increases rigidity of the bearing cap assembly 5. Furthermore, the upper plate 16 properly positions the mini-caps 14 relative to the bearing caps 10 such that the mini-caps 14 are properly aligned with the bearing caps 10 upon incorporation of the bearing cap assembly 5 into an engine. An additional advantage of the modular construction includes a lighter weight component having near net shape bearing cap features. Moreover, the bearing cap assembly 5 is easier to manufacture by allowing for greater machining operation tolerances. Furthermore, there is a lower capital equipment investment required to produce the bearing cap assembly 5 resulting in an overall reduced cost to the consumer. Yet another advantage of the modular configurations is replacement and/or repair of the bearing cap assembly 5 is cost effective and does not require replacement of the entire assembly.

Each mini-cap bearing cap 20 and main bearing cap 18 also includes a crankshaft bore 24 for connecting the bearing cap assembly 5 to the crankshaft of an engine. The lower plate 12 aligns the mini-cap bearing caps 20 and the main bearing caps 18 such that the crankshaft of the engine properly aligns with the bearing cap assembly 5. Mounting bolts 30 with ferrules secure the lower plate 12 to the mini-cap bearing caps 20 and the main bearing caps 18. For example, the mounting bolts 30 may be pressed or forced into the mini-cap bearing caps 20 and the main bearing caps 18. Mini-cap bolts 32 with ferrules are utilized to secure the upper plate 16 and the mini-caps 14 to the mini-cap bearing caps 20.

The main bearing caps 18 may require minor machining operations. In addition, the mini-cap bearing caps 20 may require machining. For example, the fractured joint 26 at the mini-cap joint face area of the mini-cap bearing cap 20, which is fracture split to provide a precisely confronting mini-cap joint face surface may require machining. Hollow dowels 28 are pressed into each bearing cap 10 and are kitted to a fixture nest, as illustrated in FIG. 3. Finally, the bearing cap assembly 5 may be installed onto an engine for the line boring operation, as one assembly.

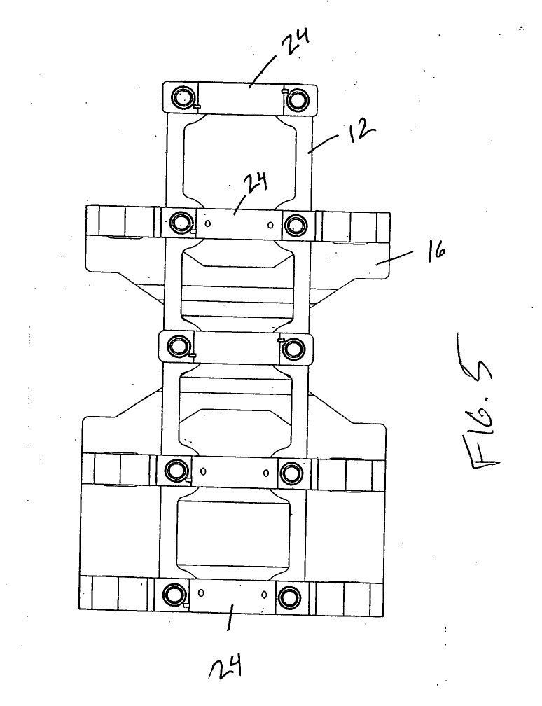

FIG. 4 illustrates a top plan view of the bearing cap assembly 5; and FIG. 5 is a bottom plan view of the bearing cap assembly 5. The upper plate 16 and the lower plate 12 are positioned to connect to opposing ends of the mini-cap bearing caps 20 and main bearing caps 18. To this end, the upper plate 16 and the lower plate 12 provide a rigid structure for offsetting imbalance forces produced by an engine. For instance, the upper plate 16 and the lower plate 12 allow a balance shaft to rotate or otherwise move within the shaft bore of the mini-cap bearing caps 20. Upon assembly to an engine, the upper plate 16 and the lower plate 12 properly align the balance shaft such that movement of the balance shaft cancels vibrational and rotational imbalances produced by the engine. In addition, the lower plate 12 and the upper plate 16 are designed such that a lubricating material, such as oil, can penetrate and/or flow within the bearing cap assembly 5.

Preferably, each mini-cap bearing cap 20 is manufactured from powder metal. A powder metal material is compacted and sintered to form the mini-cap bearing cap 20, providing a near-net-shape part for the balance shaft. Manufacturing the mini-cap bearing cap 20 in such an embodiment significantly reduces the amount of machining needed to manufacture the mini-cap bearing cap 20, thereby reducing manufacturing time and production costs. Manufacturing mini-cap bearing caps 20 of metal powder reduces the weight of the bearing cap assembly 5. Moreover, the powder metal bearing cap assembly 5 is substantially lighter than comparable cast-iron parts, enabling fuel efficiency to be increased and providing a dramatic improvement over sand-cast ductile iron products. As such, the mini-cap bearing caps 20 require less machining, provide more design options, and allow the material to be broached and fracture split at the mini-cap joint face, which would be impossible with bearing caps produced from ductile iron.

Although the preferred embodiment of the present invention has been illustrated in the accompanying drawings and described in the foregoing detailed description, it is to be understood that the present invention is not to be limited to just the preferred embodiment disclosed, but that the invention described herein is capable of numerous rearrangements, modifications and substitutions without departing from the scope of the claims hereafter.

Having thus described the invention, we claim:

1. A bearing cap assembly for housing a balance shaft, said bearing cap assembly comprising:
at least one bearing cap having a mini-cap bearing cap portion and a mini-cap portion, wherein a fault line extends along the bearing cap between the mini-cap portion and the mini-cap bearing cap portion wherein the mini-cap portion and the mini-cap bearing cap portion are separable along the fault line and further wherein the mini-cap bearing cap portion secures to the mini-cap portion to form a shaft bore sized to receive the balance shaft; and
a crankshaft bore connected to said bearing cap.

2. The bearing cap assembly of claim 1 further comprising:
a first plate connecting the bearing cap to a second bearing cap.

3. The bearing cap assembly of claim 2 further comprising:
a main bearing cap connected to said first plate, said bearing cap and said second bearing cap.

4. The bearing cap assembly of claim 3 further comprising:
a crankshaft bore formed within said main bearing cap.

5. The bearing cap assembly of claim 4 further comprising:
a second plate connecting the mini-cap portion to the mini-cap bearing cap portion.

6. The bearing cap assembly of claim 1 wherein shaft journals are formed within the mini-cap portion and the mini-cap bearing cap portion.

7. The bearing cap assembly of claim 6 wherein the mini-cap portion is separated from the mini-cap bearing cap portion by fracture splitting said bearing cap.

8. The bearing cap assembly of claim 1 further comprising:
bolts connecting said mini-cap portion to said mini-cap bearing cap portion.

9. The bearing cap assembly of claim 1 wherein said bearing cap has at least two shaft bores.

10. The bearing cap assembly of claim 1 wherein said crankshaft bore is integrally formed with said mini-cap bearing caps.
